(19) United States
(12) Patent Application Publication
(10) Pub. No.: US 2011/0251951 A1
(43) Pub. Date: Oct. 13, 2011

(54) ANTI-FRAUD EVENT CORRELATION

(76) Inventors: Dan Kolkowitz, Los Altos Hills, CA (US); Taher Elgamal, Atherton, CA (US)

(21) Appl. No.: 13/085,819

(22) Filed: Apr. 13, 2011

Related U.S. Application Data
(60) Provisional application No. 61/323,373, filed on Apr. 13, 2010.

(51) Int. Cl. G06Q 40/00

(52) U.S. Cl. 705/39

(57) ABSTRACT

Methods, systems, appliances and/or apparati related to identifying potential fraud associated with financial transactions are provided. An example system for identifying potentially fraudulent financial transactions may include transaction-model databases, a fraud assessment engine operably coupled to the transaction-model databases, and a reporting engine operably coupled to the fraud assessment engine. The transaction-model databases may be configured to store transaction-model data associated with a plurality of historical financial transactions. The transaction-model data may include a plurality of attribute data corresponding to a respective attribute of the historical financial transactions. The fraud assessment engine may generate a fraud assessment based (at least in part) on a comparison of current financial transaction attribute data (and/or or the values thereof) with at least a portion of the transaction-model data. The reporting engine may generate a fraud assessment report and/or a fraud alert signal based (at least in part) on the fraud assessment.

### CROSS-REFERENCE TO RELATED APPLICATIONS

This application claims the benefit of U.S. Provisional Application Ser. No. 61/323,373, entitled “ANTI-FRAUD EVENT CORRELATION,” filed on Apr. 13, 2010, the disclosure of which is incorporated herein by reference.

### BACKGROUND

The present disclosure generally relates to identifying fraud associated with financial transactions, and, more particularly, to identifying potentially fraudulent financial transactions based on statistical analysis of data associated with such financial transactions.

Online merchants (e.g., merchants selling products or services on the Internet), charities, governments and other service institutions accept credit cards and other payment forms (e.g. PayPal, Google Checkout) for online transactions. Forms of payment may be collectively referred to as payment instruments. The credit card and payment industries have developed technologies to support payments where there is no physical card for the merchant to examine. These transactions are called “card not present transactions,” which form the bulk of paid transactions on the Internet. In general, these transactions are initiated by consumer devices like personal computers, smart phones, internet ready TVs, game consoles and the like (hereinafter referred to as computers or computing devices.

Online merchants may accept payment instruments from customers and present them to a payment gateway with whom they have contracted. The payment gateway may be a payment service operated by a payment processor that communicates transactions to appropriate payment parties and networks that support the issuers and recipients of these payment instruments being used in the transactions. The issuer may be a bank that issued the card and which is responsible for paying the merchant. The bank has a relationship with the payment instrument owner and is responsible for payment being accepted or rejected. When the payment gateway receives the response from the issuer on whether or not they will fund the transaction, the merchant may deliver the good or service to the customer or not (e.g., in the case of a decline by the issuer or if there are other reasons to be suspicious).

The communication with the payment gateway may occur through an application programming interface (API). The API may contain all the information required for a bank (or relevant financial party) to process a transaction. This may include a credit card ID, an amount being charged, a transaction description, card security information entered by the user, a transaction ID, and other fields that may be required by a particular payment gateway and/or issuing party. An internet protocol (IP) address may also be used by some payment gateway interfaces. The credit card security information may be used to help establish that a customer is the actual legal owner of the card in such “card not present” situations. Typical card information may include the address and phone number which have been associated with the card, the 3 or 4 digit “CVV” (which is a random value on the back of the physical payment instrument), and the expiration date printed on the physical payment instrument. This information is known by the bank and may be compared against the data provided with the transactions sent through the payment gateway by the merchant. This data is requested of the customer or user making the transaction with the payment instrument. The matching of the information with the stored information is intended to verify that the person is in possession of the actual card and can present this information on it. Other forms of payment have different security features, but in general they are all trying to achieve the same goal: establish ownership of the payment instrument.

In instances where the payment instrument has been stolen and/or is being used illegally, the money charged to the payment instrument and paid by the bank is, in most cases, returned to the consumer being defrauded. The contractual agreement between the merchants, the payment gateways, the card associations, the banks and other relevant payment parties typically contains legal and financial obligations for accepting fraudulent transactions and returning the money that has been charged to the consumer. In some cases, the merchant may be liable for any money that is lost due to fraud associated with card-not-present transactions. In contrast, the losses for fraud with card present transactions are borne by the bank authorizing the transactions.

Fraudulent transactions may involve stolen payment instruments, payment instruments illegally issued to people using stolen identities, and “friendly fraud.” Friendly fraud may be fraud that capitalizes on the lack of information and proof that the actual owners of the payment instruments executed the transactions. Friendly fraud is on the rise because it is particularly difficult for merchants to dispute a fraud case where they cannot prove the consumer executed a given transaction.

Many conventional anti-fraud systems rely on databases built from previous transactions. On receipt of a new transaction using a card at their processing centers, conventional systems look for fraud through analyzing the card's transaction history. The analysis compares the history of the purchases and information for the individual card to see whether the current purchase is consistent with that past activity. The behavior may be characterized and actions are taken (including declining the transaction) when a transaction is seen to diverge in a significant way from its regular behavior. When this happens, the card may be put on a suspicious or banned list. Until that situation is changed, the current and subsequent transactions for the card may be rejected. This is called “behavioral analysis”. Behavioral analysis largely does not work for newly issued cards because there is no historical data for these cards.

Other approaches are based on device reputation, the device being a computer, phone and/or other device the user is using when making the transaction. The reputation is based on historical information. The reputation of the device changes when it has been associated to a previously observed “bad” credit card. Much the same as with “bad” cards, devices are added to black or banned lists. This enables merchants to compare on a per transaction basis whether a given device has in the past been associated to a bad card, and therefore reject transactions that come from these devices.

### SUMMARY OF THE DISCLOSURE

A first aspect of the present disclosure provides a system for identifying potentially fraudulent financial transactions. Such system may include one or more transaction-model databases, a fraud assessment engine operably coupled to the one or more transaction-model databases, and a reporting engine operably coupled to the fraud assessment engine. The transaction-model databases may be configured to store transaction-model data associated with a plurality of historical financial transactions. The transaction-model data may include a plurality of attribute data corresponding to a respective attribute of the historical financial transactions. The fraud assessment engine may be configured to generate a fraud assessment based (at least in part) on a comparison of current financial transaction attribute data with at least a portion of the transaction-model data. The reporting engine may be configured to generate a fraud assessment report and/or a fraud alert signal based (at least in part) on the fraud assessment.

A second aspect of the present disclosure provides a method of assessing financial transactions for fraudulent activity. Such method may include receiving, by a fraud assessment appliance, current financial transaction data associated with current financial transactions. The current financial transaction data may include a plurality of current attribute data corresponding to a respective attribute of the current financial transactions. Such method may also include comparing, by the fraud assessment appliance, at least one current attribute data of the current attribute data to historical attribute data corresponding to a respective attribute of a plurality of historical financial transactions. Such method may also include generating, by the fraud assessment appliance, a fraud assessment based (at least in part) on the comparing operation. Such method may further include generating, by the fraud assessment appliance, a fraud assessment report and/or a fraud alert signal based (at least in part) on the fraud assessment.

A third aspect of the present disclosure provides an appliance for identifying potentially fraudulent financial transactions. Such appliance may include one or more attribute databases, a correlation component operably coupled to the attribute databases, an assessment component operably coupled to the correlation component, and reporting component operably coupled to the fraud assessment component. The attribute databases may be configured to store attribute data corresponding to respective attributes of a plurality of historical financial transactions. The correlation component may be configured to generate correlated attribute data groups, and may be further configured to generate a plurality of statistical models. Each statistical model may be associated with a respective one of the correlated attribute data groups. Further, the fraud assessment component may be configured to generate a fraud assessment based (at least in part) on a comparison of attribute data of current financial transactions to at least one of the statistical models. The reporting component may be configured to generate a fraud assessment report and/or a fraud alert signal based (at least in part) on the fraud assessment.

A fourth aspect of the present disclosure provides a system for identifying potentially fraudulent financial transactions. Such a system may include one or more attribute databases, a fraud assessment engine operably coupled to the attribute databases, and a reporting engine operably coupled to the fraud assessment engine. The attribute databases may be configured to store a plurality of attribute data corresponding to respective attributes of financial transactions. The fraud assessment engine may be configured to generate a fraud assessment based (at least in part) on an anomalous distribution of at least one of the attribute data. The reporting engine may be configured to generate a fraud assessment report and/or a fraud alert signal based (at least in part) on the fraud assessment.

A fifth aspect of the present disclosure provides a system for identifying potentially fraudulent financial transactions. Such a system may include one or more attribute databases, a fraud assessment engine operably coupled to the attribute databases, and a reporting engine operably coupled to the fraud assessment engine. The attribute databases may be configured to store a plurality of attribute data corresponding to respective attributes of financial transactions. The fraud assessment engine may be configured to generate a fraud assessment based (at least in part) on statistical trends of at least one of the attribute data. The reporting engine may be configured to generate a fraud assessment report and/or a fraud alert signal based (at least in part) on the fraud assessment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a diagram depicting some example systems for identifying potentially fraudulent financial transactions;

FIG. 2 is a flowchart depicting some example methods of assessing financial transactions for fraudulent activity;

FIG. 3 is a diagram depicting some example appliances for identifying potentially fraudulent financial transactions;

FIG. 4 is a diagram depicting some example systems for identifying potentially fraudulent financial transactions;

FIG. 5 is a diagram depicting some example systems for identifying potentially fraudulent financial transactions;

FIG. 6 is a diagram depicting some example systems for identifying potentially fraudulent financial transactions;

FIG. 7 is a diagram depicting some example environments in which example embodiments may operate, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is drawn, inter alia, to methods, systems, appliances and/or apparati related to identifying potential fraud associated with financial transactions, and, more particularly, to identifying potentially fraudulent financial transactions based on statistical analysis of data associated with such financial transactions.

In general, the present disclosure provides for the identification of fraud through analysis of collections of transactions and their attributes. Some embodiments rely on statistical models to identify suspicious transactions. Example transactions are represented as a collection of attributes that are appearing in time. When a value for an attribute seems to occur at an unusual frequency (among all the transactions being observed), the transactions containing those attributes may be flagged as potential fraud. In some examples, the fact that a single attribute appears “too frequently” in apparently unrelated transactions may be taken as an indication that they are actually related. This provides a new and unique ability to identify fraud in real time and spot new online attacks.

Exemplary embodiments may permit observation of correlations of attributes in Internet payment transactions for the purpose of identifying payment fraud. An example system examines attributes seen in payment transactions passed from merchants, through payment gateways or networks, or directly from banks and builds a statistical model of the regular behavior of those attributes. These attributes are any values which can be seen as part of the regular payment transactions, even if they do not seem to be relevant to the actual identity or value of the transactions being performed. Since the vast majority of transactions are legitimate, an example system creates a model, which provides the regular behavior for those attributes in the payment transactions. When the behavior varies in a statistically significant way for any of the attributes, there is reason to believe that fraud may be involved. An example system provides a capability to identify suspected fraud related to all forms of identity theft, credit card fraud and suspicious transactions.

In some exemplary embodiments, the regular behavior is determined over intervals and specific time periods and may be for specific banks, merchants, geographies, individuals or companies or globally across the whole payment network or Internet. The insight that fraud may be involved is given by the monitoring of the regular behavior over time, and may not be observable by the bank or with existing anti-fraud systems running at the merchant—i.e. every transaction may look legitimate according to all the criteria that current anti-fraud systems deploy. An example system relies on seeing the attributes appearing in multiple transactions which may or may not be visible to the merchant or entity involved in taking the payment.

In some exemplary embodiments, when unusual behavior is observed compared with the regular behavior, an example system identifies those transactions that caused the irregular behavior as being potentially involved with payment fraud. In the case of one particular bank, for example, the transactions and activity are monitored for that bank and all of the variables are monitored for that bank. Consider the parameter “number of transactions”: If an unusual number of transactions come to that bank in a period of time then those transactions can be looked at as potentially involved with fraud. Another example is IP sub-network: If an unusual number of transactions in a period of time are coming from one IP sub-network, then those addresses can be inferred to be potential sources of fraudulent activity.

In some exemplary embodiments, the attributes utilized in an example system are any of those that can be regularly seen in the case of payment at any of the typical observation points, such as a payment gateway, a payment processor, merchant, bank and/or other organization receiving payment, for example. Depending upon where the attributes are seen, then different correlations can be made. For example, an example system is designed to sit in a payment gateway center. There credit, debit or other payment devices will be passed from merchants through to the banks or servicing organizations that service the cards.

In some exemplary embodiments, an example system may introduce the notion of the frequency and time analysis of network and user data to identify payment fraud. Similar approaches have been deployed in other domains. For example, anti-fraud analytic systems may look at the usage pattern of payment for an individual or given card to determine that fraud is occurring. There has not been a system that correlates all the network, user attributes, and merchant attributes to see the general behavior of those attributes in payment transactions to identify fraud in real-time. In some examples, real-time may mean actual real-time, near real-time or substantially real-time.

In some exemplary embodiments, an example system receives feeds of raw transactions including the network merchant data for transactions and observes regular behavior for configured attributes and observes them over time. The regular behavior for the attributes is determined for observed periods of time. When unusual frequencies or clustering of critical attributes is observed, fraud involving those particular attributes can be inferred.

Further, in some exemplary embodiments, an example system recognizes relations that are known to exist between attributes, and can then be seen to exist in a given time period. An example system receives data and extracts attributes from all the transactions that are seen. For each transaction, the attributes that are known to be unique can be extracted and presented to an example system. An example system observes unusual clustering of the attributes as a recognition of fraud. For example, one or more of the following clusterings may be observed by an example system:
An abnormal number of transactions in a short period of time from a given IP address or range of IP addresses.
An abnormal number of transactions with a given credit card number or range of credit card numbers (for example, transactions appearing form a number of credit cards that are close in issuing number)
An abnormal number of transactions from a given bank or credit card issuer.
An abnormal number of transactions for a given amount of money.
An abnormal number of transactions from or to a given physical address
An abnormal number of transactions from or two a given geographical area

Some exemplary embodiments may be unique in that they are not aligned with any specific party belonging to the transaction but simply looks at distributions of attributes that can be seen in the payment process.

The present disclosure contemplates that, as fraudsters become more clever, the identity of the users may be disguised by network technology. Merchants who perform anti-fraud cannot associate users with past fraudulent transactions since they see only snapshots of behavior of the fraudulent users and this might not provide enough data to make determinations. Since Internet fraud is often done repeatedly from the same computers and addresses, an example system provides a powerful tool to identify potentially problematic users and sites.

In some exemplary embodiments, the data is passed in from the transaction partner. In some exemplary embodiments, there can be layers of correlations between parameters as well. For example, we can check the distribution of credit card numbers only—which would be a first degree correlation, or sequential credit card numbers with the same merchant or the same billing or shipping address which would constitute a second degree correlation, or combine all three and so on.

Some embodiments depict these discovered relations as “events”. These may describe the transactions and their relations which are believed to be in the same fraudulent “event” that is occurring in a payment system. The transactions may contain other attributes that did not show any statistically significant correlations. In some examples, those attributes may then be regarded as significant. These may be used to find other observed transactions that also contain the same attributes having those shared values. Further, these may be identified as being related to the same event and/or involved in the same fraudulent event.

In a case where these relationships should not exist in regular payment or merchant activities there may be reason to suspect fraud. For example, the fact that many transactions are originating from the same computer using multiple cards with multiple identities may be a strong reason to suspect fraud. The transactions, which are completely independent from one another, may be correlated based on their origination: same computer or IP address, for example. This allows an example system to classify all transactions coming from this computer or IP address as potentially fraudulent, exposing the larger set of potential consequences of accepting those transactions. Then, for example, other transactions that share the payment instrument or billing address used in the transaction may also be classified as being in the suspected fraudulent event being identified.

Some embodiments offer a REST-based API, which may be similar, in essence, to the payment gateway's API previously described. Either a payment gateway or merchants may implement such API to send payment transaction information to an example system. Each of the values in the API may be regarded as an attribute of the transaction. These may include, for example, the card or payment instrument numbers, the tokens used to represent them, device identifiers, personal information entered such as billing and shipping addresses, telephone numbers, dollar values of items being purchased, item categories, transaction type, and/or the return codes given back from the gateways. For different payment gateways or merchants, a larger or smaller subset of the attributes may be passed into an example system and examined. An example system's API assembles the common elements of each transaction as a collection of “name/value” pairs—each of the elements may be “tagged” by the type of the component and its value. These may be ordered by the time they were received by the merchant or payment processor. This encoding may be through standard encoding technologies used in Web services such as JSON or XML.

An example system may build lists of those attributes and examine the frequency of occurrences of those individual values for those attributes in each list along with the payment transaction type. In some examples, it may be assumed that in non-fraudulent transactions, the values for the attributes occur with a frequency that reflects regular usage of the cards in the observed payment environment. The system may alert fraudulent behavior when attributes are behaving differently than their normal expected behavior. The details of examining the lists and the attributes are described below for some examples.

A simple example provides the examination of the relation of IP addresses: In some examples, it may be expected that multiple transactions should not originate from the same IP address or computer in very close proximity in time. The close proximity in time of transactions may be seen as a potential indicator of fraud. A list of transactions for a given IP address with the time values of when they occurred may show suspicious activity on the basis of multiple sites being accessed in a close period of time or even multiple cards used in a close period of time from a given IP address. An example embodiment detects these cases and may be able to identify those related transactions and IP address as potentially involved in fraud on the basis of such irregular statistical behavior.

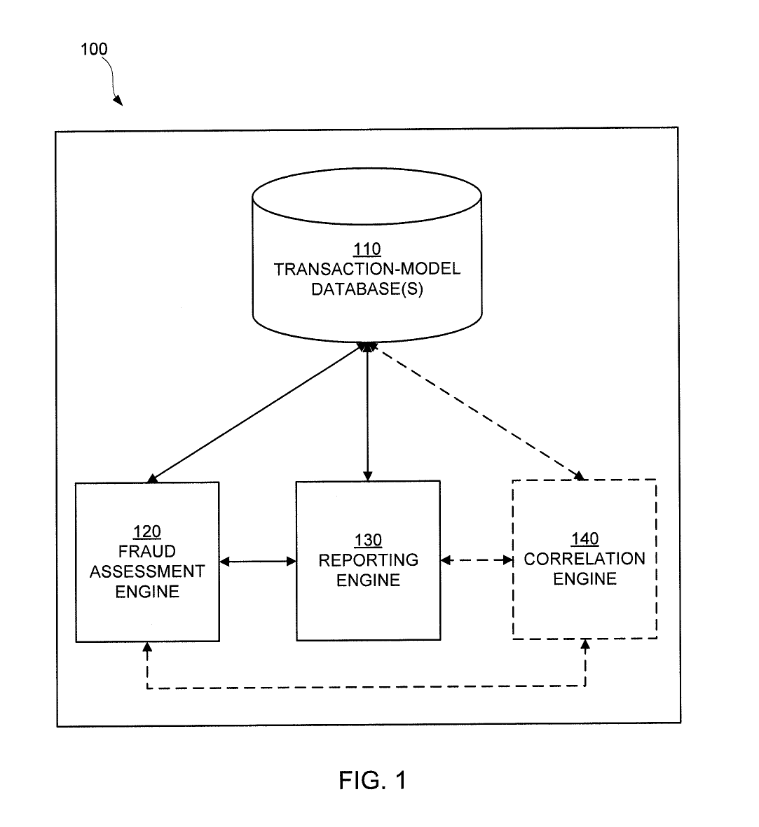

In some example embodiments, as generally depicted in FIG. 1, a system 100 for identifying potentially fraudulent financial transactions may be provided. Such system 100 may include one or more transaction-model databases 110, a fraud assessment engine 120 operably coupled to the one or more transaction-model databases 110, and a reporting engine 130 operably coupled to the fraud assessment engine 120. The transaction-model databases 110 may be configured to store transaction-model data associated with a plurality of historical financial transactions. The transaction-model data may include a plurality of attribute data corresponding to a respective attribute of the historical financial transactions. The fraud assessment engine 120 may be configured to generate a fraud assessment based (at least in part) on a comparison of one or more current financial transactions with at least a portion of the transaction-model data. The reporting engine 130 may be configured to generate a fraud assessment report and/or a fraud alert signal based (at least in part) on the fraud assessment.

In some examples, the fraud assessment engine 120 may generate the fraud assessment based (at least in part) on a comparison of the one or more current financial transactions with at least a portion of the plurality of attribute data.

In some examples, the system 100 may further include a correlation engine 140 operably coupled to the transaction-model databases 110, the correlation engine 140 may be configured to correlate attribute data corresponding to respective attributes of the plurality of historical financial transactions to generate one or more correlated attribute data groups. The fraud assessment engine 120 may generate the fraud assessment based (at least in part) on a comparison of the current financial transactions with at least a portion of the correlated attribute data groups.

In some examples, the plurality of attribute data may include payment instrument identification data, transaction amount data, transaction description data, payment instrument security data, payment instrument user data, transaction identification data, originating computer data, internet protocol (IP) address data, payment gateway data, payment gateway identification data, payment instrument issuer identification data and/or payment instrument issuer data.

In some examples, the fraud assessment engine 120 may be further configured to generate a plurality of statistical models associated with the plurality of attribute data, each statistical model corresponding to at least one attribute data of the plurality of attribute data. In some examples, the fraud assessment engine 120 may be further configured to generate the fraud assessment based (at least in part) on a comparison of at least one of plurality of statistical models with current financial transaction attribute data. In some examples, the assessment engine may be configured to generate the fraud assessment in real-time and/or near real-time. In some examples, the reporting engine may be configured to generate a fraud assessment report and/or a fraud alert signal in real-time and/or near real-time.

In some examples, the fraud assessment engine 120 may be further configured to generate the fraud assessment based (at least in part) on a predetermined amount of deviation (or number of deviations) of at least one of the current attribute data from at least one of the plurality of statistical models. Example predetermined amounts of deviation may include, without limitation:
a predetermined deviation of a number of credit card approvals for the same credit card occurring over a predetermined period of time;
a predetermined deviation of a financial transaction amount;
a predetermined deviation of a number of financial transaction denials for the same account occurring over a predetermined period of time;
a predetermined deviation of a number of different merchants transacted with for the same account over a predetermined period of time;
a predetermined deviation of a number of internet protocol (IP) addresses from which financial transactions occur for the same account over a predetermined period of time;
a predetermined deviation of a number of substantially similar financial transaction amounts occurring for the same account over a predetermined period of time;
a predetermined deviation of a number of different accounts used for transactions on the same internet protocol (IP) address over a predetermined period of time;
a predetermined deviation of a number of a group of internet protocol (IP) addresses used for a predetermined number of financial transactions over a predetermined period of time;
a predetermined deviation of a number of a combination of approved and declined financial transactions for the same account occurring over a predetermined period of time;
a predetermined deviation of a number of financial transactions utilizing a predetermined set of distinct bank identification numbers seen at a merchant over a predetermined period of time;
a predetermined deviation of a number of descending financial transaction amounts attempted for the same account over a predetermined period of time;
a predetermined deviation of a number of the same financial transaction amounts attempted and declined with a merchant over a predetermined period of time; and/or
a predetermined deviation of a number of different billing addresses reported for the same account over a predetermined period of time.

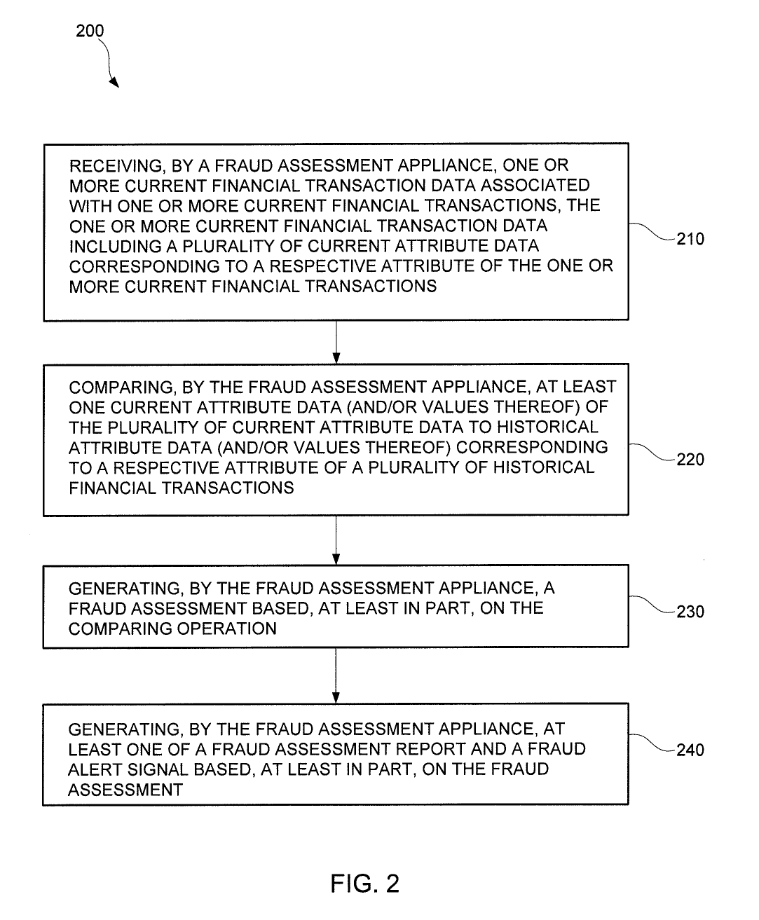

In some example embodiments, as generally depicted in FIG. 2, a method 200 of assessing financial transactions for fraudulent activity may be provided. Such method 200 may include receiving (at item 210), by a fraud assessment appliance, current financial transaction data associated with current financial transactions. The current financial transaction data may include a plurality of current attribute data corresponding to a respective attribute of the current financial transactions. Such method 200 may also include comparing (at item 220), by the fraud assessment appliance, at least one current attribute data of the current attribute data to historical attribute data corresponding to a respective attribute of a plurality of historical financial transactions. Such method 200 may also include generating (at item 230), by the fraud assessment appliance, a fraud assessment based (at least in part) on the comparing operation (at item 220). Such method 200 may further include generating (at item 240), by the fraud assessment appliance, a fraud assessment report and/or a fraud alert signal based (at least in part) on the fraud assessment.

In some examples, fraud may also be detected based on identifying attribute data that has previously been characterized as fraudulent and/or potentially fraudulent. Similarly, when attribute data has been identified as fraudulent and/or potentially fraudulent, other transactions that include such attribute data may also be characterized as fraudulent and/or potentially fraudulent. For example, if the system identifies that a credit card number has been involved in fraudulent activity in a transaction, the system may use the attribute data associated with the transaction to identify other transactions having the same attributes and characterize them as fraudulent. Such other transactions identified may be ones retrieved from the database as past, previous or historical transactions or ones that are observed subsequent to the identification of this event.

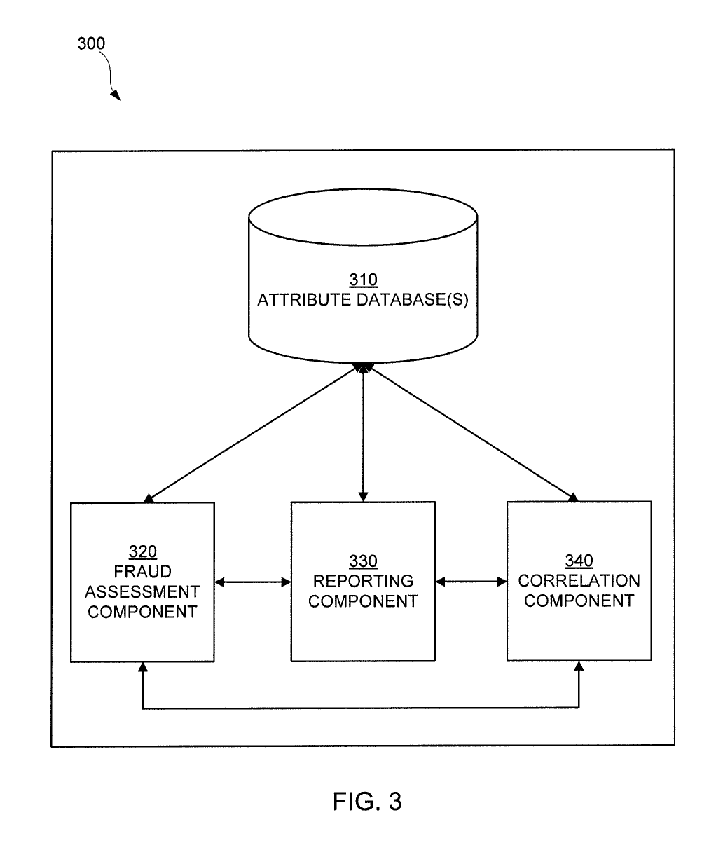

In some example embodiments, as generally depicted in FIG. 3, an appliance 300 for identifying potentially fraudulent financial transactions may be provided. Such appliance 300 may include one or more attribute databases 310, a correlation component 340 operably coupled to the attribute databases 310, a fraud assessment component 320 operably coupled to the correlation component 340, and reporting component 330 operably coupled to the fraud assessment component 320. The attribute databases 310 may be configured to store attribute data corresponding to respective attributes of a plurality of historical financial transactions. The correlation component 340 may be configured to generate correlated attribute data groups, and may be further configured to generate a plurality of statistical models. Each statistical model may be associated with a respective one of the correlated attribute data groups. Further, the fraud assessment component 320 may be configured to generate a fraud assessment based (at least in part) on a comparison of attribute data of current financial transactions to at least one of the statistical models. The reporting component 330 may be configured to generate a fraud assessment report and/or a fraud alert signal based (at least in part) on the fraud assessment.

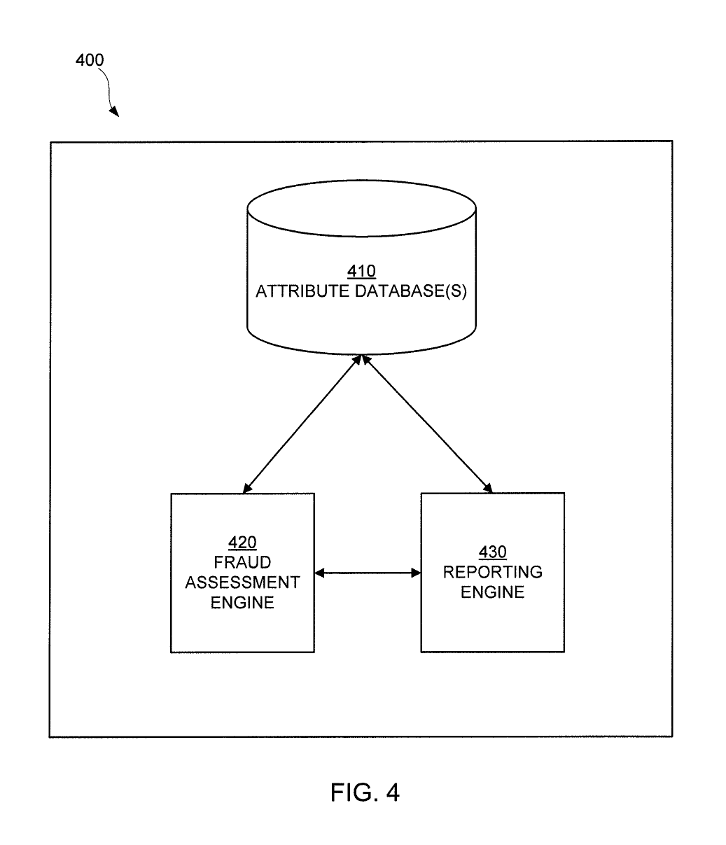

In some example embodiments, as generally depicted in FIG. 4, a system 400 for identifying potentially fraudulent financial transactions may be provided. Such a system 400 may include one or more attribute databases 410, a fraud assessment engine 420 operably coupled to the attribute databases 410, and a reporting engine 430 operably coupled to the fraud assessment engine 420. The attribute databases 410 may be configured to store a plurality of attribute data corresponding to respective attributes of financial transactions. In some examples, the fraud assessment engine 420 may be configured to generate a fraud assessment based (at least in part) on an anomalous distribution of at least one of the attribute data. In some examples, the fraud assessment engine 420 may be configured to generate a fraud assessment based (at least in part) on statistical trends of at least one of the attribute data. The reporting engine 430 may be configured to generate a fraud assessment report and/or a fraud alert signal based (at least in part) on the fraud assessment.

Example embodiments do not necessarily require past information of a payment instrument to evaluate the potential fraud associated to a given transaction. Instead, because of being able to evaluate every transaction in the context of all transactions from multiple angles in real-time or near real-time: Payment Instrument, Bank Identification Number (BIN), merchant, IP address, Billing Zip code, device, and the like. Some example embodiments may identify fraudulent behavior without prior history. Furthermore, some example embodiments may be able to identify fraud that can only be detected by analyzing transactions from every angle.

For example, a model for merchant fraud (e.g., merchants that are fraudulent themselves) may include activities where merchants steal payment instruments (e.g., credit cards, debit cards) from a specific issuer. The merchant may funnel batches of stolen credit cards through the payment gateway as if they were real transactions. The ability to do this requires only the opening of the accounts with the payment gateway and bank and then this variety of fraud may easily be committed. Because example embodiments may be capable of analyzing data based on BIN and merchants, it may be able to identify an anomalous distribution of transactions where credit cards are largely from the same issuer. This is not possible by analyzing the individual credit card, the individual transaction or the reputation of the device that is using it. Instead, the identification of the fraudulent merchant and credit card activity may be from observing the percentage of credit cards from a particular bank (the BIN) being used exceeding the pre-determined deviation of the overall percentage from all BINs being used at that merchant. When an example embodiment detects this, it may notify the gateway of the likelihood that fraud is being committed by the actual merchant.

In addition, since some examples analyze a large set of transactions in real time, as opposed to individual transactions, they may identify new trends of fraud. An example is Internet fraud, where fraudsters may use large sets of computers (e.g. botnets) with a large set of stolen payment instruments. Observing correlations among transactions involved in the transactions originating from the multiple computers may show the originating relationship between these transactions and help identify them as part of a network of controlled computers (e.g., “botnet”).

The analysis of transactions through statistical analysis of their attributes in real time may be unique to some example embodiments. With this example embodiment, new behaviors may be seen as related to others in a group of transactions and may thus be seen as potentially being part of a larger use of a card or cards in fraudulent transactions.

In some examples, the behavior of the transactions may be monitored for one or more of the merchants, the banks, the IP address, subnetwork, addresses around a subnetwork, the IP addresses of the owner of the card or instrument, credit card numbers, billing addresses, shipping addresses and/or other attributes that may be determined to be part of the normal flow of a transaction. In some exemplary embodiments, one or more of the following properties may be monitored: transactions from IP addresses (one address or close ones), credit card numbers (one number or ones that are close), and/or billing or shipping addresses being reused.

In some exemplary embodiments, an example system may be tied to other anti-fraud systems that currently exist. For example, many anti-fraud vendors maintain black-lists of IP address or credit card numbers. With this example embodiment, the list can be supplemented with an online check to see whether or not the payment being processed may be involved with fraud. When a known element of fraud is seen in a transaction, then any elements associated with it can then be watched for in the real time transactions seen by an example system. For example, if a credit card on a blacklist (a known bad credit card) is used, then all the IP addresses close to that one (e.g. on the same subnet) can be watched and then those transactions identified as suspicious. Similarly, credit cards close in number to that one can also be watched since there is a pattern of theft of close credit card numbers used in fraud.

Similarly, in some exemplary embodiments, an example system may alert merchant or financial entities of the suspicion of attributes that may belong to transactions. Then they can build their own black lists around those entities that have been identified as associated with the fraud.

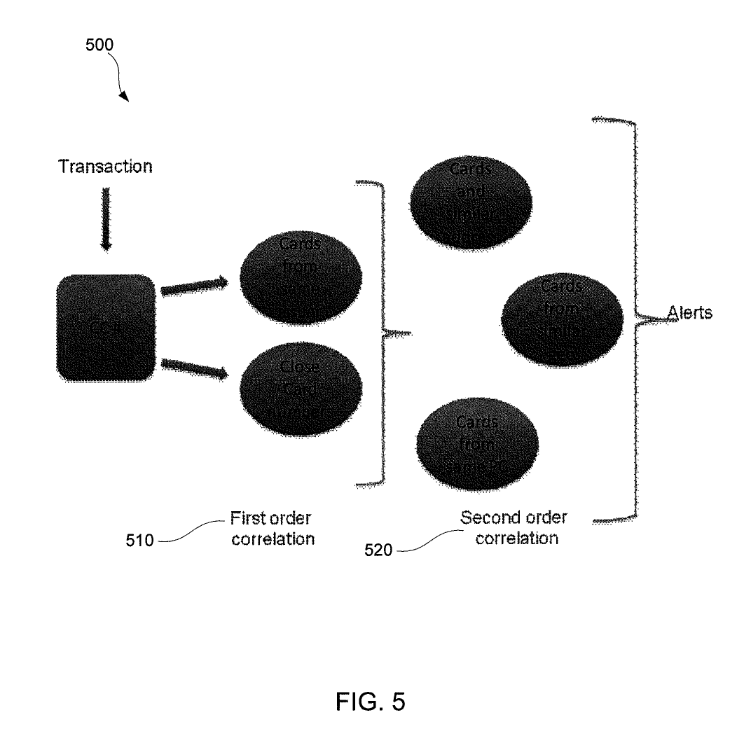

FIG. 5 shows an example of multi layer correlation 500 as applied to the online anti-fraud problem. Each layer 510, 520 produces information about the “normality” of the transactions going through the node being investigated. For example, a first correlation layer 510 may relate to correlations of payment instruments from the same issuer and closely numbered payment instruments, for example. A second correlation layer 520 may relate to correlations of payment instruments with similar addresses, payment instruments from a certain geographical area, and payment instruments used from the same computing device, for example.

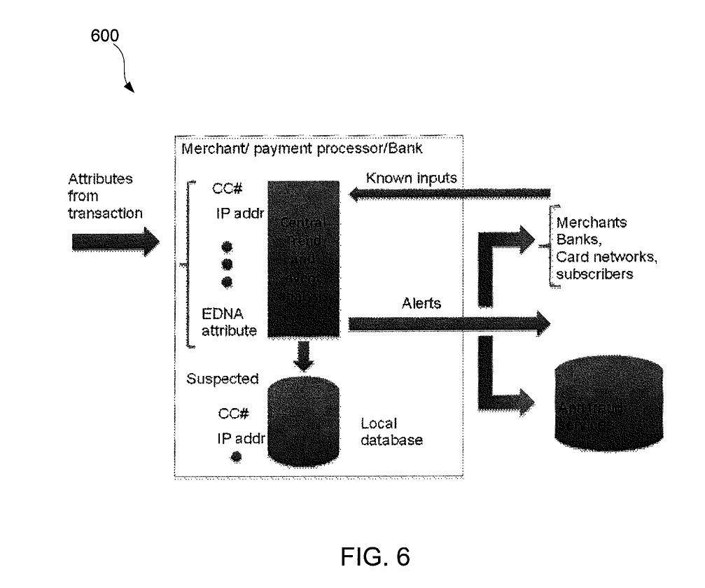

In some exemplary embodiments, an example system produces information to many points in the payment eco-system to manage fraud. Alerts are generated whenever a suspicious transaction passes through the system to the issuing bank, processor, merchant and other anti fraud systems. FIG. 6 shows some of the flows of data with respect to an example system 600 and the other parts of the eco-system.

The present disclosure contemplates that with Web2.0, network services may follow a common architecture. E-merchants may provide web applications in browsers that access their applications using standard application frameworks to support their online retail businesses.

The present disclosure contemplates that, in this way, many parameters can be seen in the payment network and through the flow of online payment transactions. The merchant can collect data and pass it through to the payment gateway or payment processor as part of their API calls. The parameters can be listed as XML or JSON parameters, and do not have to be supported in every part of the payment network to have the transaction go through.

The present disclosure contemplates that exemplary embodiments of an example system may observe correlations between data components that may or may not be associated with the actual payment. A statistical model is built around key variables that can be characterized as having normal values. When a statistically significant change is observed in the normal distribution or value of the variables a discovery of fraud surround the variables and their use can be made.

The present disclosure contemplates that, for example, uses of credit cards should appear distributed around the total allocation of credit cards. But, theft of credit cards from a bank may be all at once and contain card numbers which are closely related. An example system will see that in a short period of time cards are being used in closer proximity than in normal frequency. This would indicate fraud and the bank would be notified of the range of cards that have been observed.

Some exemplary embodiments may take a real-time stream of credit card transactions from any source (currently files or a REST API using JSON) and pass them through a ‘cleanup’ phase, which may include operations such as:
Throttling (if necessary)
Masking CCNs to identify common parts of the numbers for comparison
Parts of the CCN may be uniquely hashed for security reasons
Filtering done based on the BIN (bank identification number) (rejected if the BIN is in a reject list)
Transaction timestamps verified (or created as injection time if the CCTx is not timestamped)
Transaction IDs are created (if necessary)

In some exemplary embodiments, the transaction data may be stored in the database and passed into three data structures—one representing a history of transactions for that credit card, one representing the IP address associated with the transaction (if it exists) and another representing history of transactions for the CCN's BIN. The credit card history is dynamically checked for various patterns appearing in time windows, such as:
Unusual, repeated or large transaction amounts
Many different merchant transactions
Transactions associated with many different IP address (if info is available)
Abnormal number of transactions approved or declined

In some exemplary embodiments, these anomalies generate ‘watches’ on the CCN. If they continue to occur then an ‘event’ is generated against the CCN. Events are stored in the database and may be queried.

In some exemplary embodiments, the BIN data structure is analyzed to see if, for example:
There is an unusual (historically) spike in activity for a BIN
A BIN has a high number of credit card watches/events
A BIN has an unusually large rate of CC transactions
There is an unexpected (statistically) sequence of ‘close’ credit card numbers

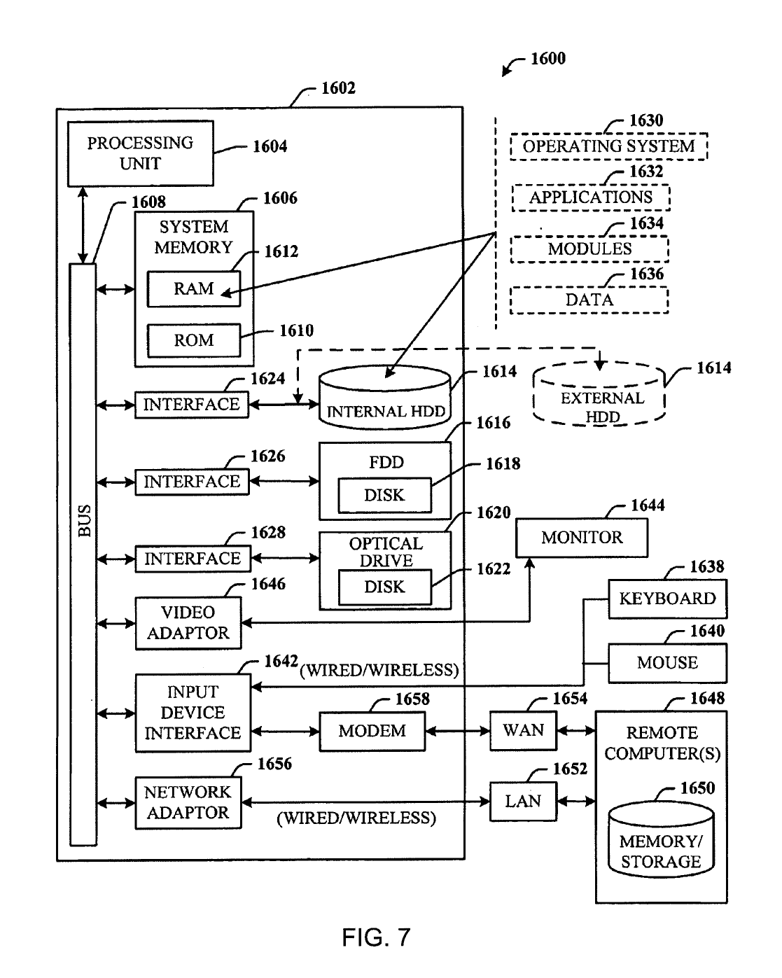

FIG. 7 illustrates an exemplary environment 1600 for implementing various aspects of an example system that includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of an example system.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is appreciated that an example system can be implemented with various commercially available operating systems or combinations of operating systems.

A user can enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for identifying potentially fraudulent financial transactions, comprising:
one or more transaction-model databases configured to store transaction-model data associated with a plurality of historical financial transactions, the transaction-model data including a plurality of attribute data corresponding to a respective attribute of the plurality of historical financial transactions;
a fraud assessment engine operably coupled to the one or more transaction-model databases, the fraud assessment engine configured to generate a fraud assessment based, at least in part, on a comparison of one or more current financial transaction attribute data with at least a portion of the transaction-model data; and
a reporting engine operably coupled to the fraud assessment engine, the reporting engine configured to generate at least one of a fraud assessment report and a fraud alert signal based, at least in part, on the fraud assessment.

2. The system of claim 1,
wherein the current financial transaction attribute data comprises values associated with the current financial transaction attribute data;
wherein the plurality of attribute data comprises values associated with the plurality of attribute data corresponding to the respective attribute of the plurality of historical financial transactions; and
wherein the fraud assessment engine generates the fraud assessment based, at least in part, on a comparison of the values of the one or more current financial transaction attribute data with the values of at least a portion of the plurality of attribute data corresponding to a respective attribute of the plurality of historical financial transactions.

3. The system of claim 1,
wherein the current financial transaction attribute data comprises values associated with the current financial transaction attribute data; and
wherein the fraud assessment engine generates the fraud assessment based, at least in part, on a comparison of the values of the one or more current financial transaction attribute data with values of at least a plurality of currently observed transactions within a predetermined period of time, without considering the plurality of historical financial transactions.

4. The system of claim 1, further comprising:
a correlation engine operably coupled to the one or more transaction-model databases, the correlation engine configured to correlate values of attribute data corresponding to values of respective attributes of the plurality of historical financial transactions to generate one or more correlated attribute data groups; and
wherein the fraud assessment engine generates the fraud assessment based, at least in part, on a comparison of the one or more current financial transaction attribute data with at least a portion of the one or more correlated attribute data groups.

5. The system of claim 1,
wherein the plurality of attribute data comprises at least one of payment instrument identification data, transaction amount data, transaction description data, payment instrument security data, payment instrument user data, transaction identification data, originating computer data, internet protocol (IP) address data, payment gateway data, payment gateway identification data, payment instrument issuer identification data and payment instrument issuer data; and
wherein the one or more current financial transaction attribute data comprises at least one of payment instrument identification data, transaction amount data, transaction description data, payment instrument security data, payment instrument user data, transaction identification data, originating computer data, internet protocol (IP) address data, payment gateway data, payment gateway identification data, payment instrument issuer identification data and payment instrument issuer data.

6. The system of claim 1, wherein the fraud assessment engine is further configured to generate a plurality of statistical models associated with values of the plurality of attribute data, each statistical model corresponding to at least one attribute data of the plurality of attribute data.

7. The system of claim 6, wherein the fraud assessment engine is further configured to generate the fraud assessment based, at least in part, on a comparison of at least one of the plurality of statistical models with current financial transaction attribute data associated with the one or more current financial transactions.

8. The system of claim 7, wherein the fraud assessment engine is further configured to generate the fraud assessment based, at least in part, on a predetermined amount of deviation in the values of at least one of the current financial transaction attribute data from at least one of the plurality of statistical models.

9. The system of claim 8, wherein the at least one of the plurality of statistical models is developed from monitoring the values of current financial transaction attribute data.

10. The system of claim 8, wherein the predetermined amount of deviation comprises a predetermined deviation of a number of credit card approvals for the same credit card occurring over a predetermined period of time.

11. The system of claim 8, wherein the predetermined amount of deviation comprises a predetermined deviation of a financial transaction amount.

12. The system of claim 8, wherein the predetermined amount of deviation comprises a predetermined deviation of a number of financial transaction denials for the same account occurring over a predetermined period of time.

13. The system of claim 8, wherein the predetermined amount of deviation comprises a predetermined deviation of a number of different merchants transacted with for the same account over a predetermined period of time.

14. The system of claim 8, wherein the predetermined amount of deviation comprises a predetermined deviation of a number of internet protocol (IP) addresses from which financial transactions occur for the same account over a predetermined period of time.

15. The system of claim 8, wherein the predetermined amount of deviation comprises a predetermined deviation of a number of substantially similar financial transaction amounts occurring for the same account over a predetermined period of time.

16. The system of claim 8, wherein the predetermined amount of deviation comprises a predetermined deviation of a number of different accounts used for transactions on the same internet protocol (IP) address over a predetermined period of time.

17. The system of claim 8, wherein the predetermined amount of deviation comprises a predetermined deviation of a number of a group of internet protocol (IP) addresses used for a predetermined number of financial transactions over a predetermined period of time.

18. The system of claim 8, wherein the predetermined amount of deviation comprises a predetermined deviation of a number of a combination of approved and declined financial transactions for the same account occurring over a predetermined period of time.

19. The system of claim 8, wherein the predetermined amount of deviation comprises a predetermined deviation of a number of financial transactions utilizing a predetermined set of distinct bank identification numbers seen at a merchant over a predetermined period of time.

20. The system of claim 8, wherein the predetermined amount of deviation comprises a predetermined deviation of a number of descending financial transaction amounts attempted for the same account over a predetermined period of time.

21. The system of claim 8, wherein the predetermined amount of deviation comprises a predetermined deviation of a number of the same financial transaction amounts attempted and declined with a merchant over a predetermined period of time.

22. The system of claim 8, wherein the predetermined amount of deviation comprises a predetermined deviation of a number of different billing addresses reported for the same account over a predetermined period of time.

23. The system of claim 1, wherein the fraud assessment engine is further configured to generate the fraud assessment based, at least in part, on a frequency of the historical financial transactions compared with the frequency of the one or more current financial transactions; and
wherein the frequency of the historical financial transactions includes the frequency of historical financial transactions associated with at least one of a payment instrument user, a shipping address, a billing address, a zip code, a geographical region, a payment instrument issuer, a payment gateway, a computing device, a plurality of computing devices, an internet protocol (IP) address and a range of IP addresses.

24. The system of claim 1, wherein the fraud assessment engine is further configured to generate the fraud assessment based, at least in part, on a frequency of the attribute data of the plurality of historical financial transactions compared with the frequency of the current financial transaction attribute data; and
wherein the frequency of the historical financial transactions includes the frequency of historical financial transactions associated with at least one of a payment instrument user, a shipping address, a billing address, a zip code, a geographical region, a payment instrument issuer, a payment gateway, a computing device, a plurality of computing devices, an internet protocol (IP) address and a range of IP addresses.

25. The system of claim 1, further comprising:
a monitoring engine configured to monitor the current financial transaction attribute data to determine if the current financial transaction attribute data is associated with one or more fraudulent financial transactions.

26. The system of claim 1, wherein the assessment engine is further configured to generate the fraud assessment based, at least in part, on the current financial transaction attribute data being associated with an abnormal frequency of the attribute data of the plurality of historical financial transactions.

27. The system of claim 1, wherein the assessment engine is further configured to generate the fraud assessment based, at least in part, on the current financial transaction attribute data associated with attribute data previously identified as potentially fraudulent.

28. The system of claim 1, wherein the assessment engine is further configured to generate the fraud assessment based, at least in part, on at least one of an amount of historical financial transactions originating from a computing device and an amount of current financial transactions originating from the computing device.

29. The system of claim 1, wherein the plurality of attribute data comprises a plurality of name/value pairs, each of the name/value pairs being associated with a respective attribute of the plurality of historical financial transactions.

30. The system of claim 1, wherein the assessment engine is further configured to assemble the one or more current financial transactions as a collection of name/value pairs, each of the name/value pairs being associated with a respective attribute of the one or more current financial transactions.

31. The system of claim 1,
wherein the assessment engine is configured to generate the fraud assessment in at least one of real-time and near real-time; and
wherein the reporting engine is configured to generate at least one of a fraud assessment report and a fraud alert signal in at least one of real-time and near real-time.

32. A method of assessing financial transactions for fraudulent activity, the method comprising:
receiving, by a fraud assessment appliance, one or more current financial transaction data associated with one or more current financial transactions, the one or more current financial transaction data including a plurality of current attribute data corresponding to a respective attribute of the one or more current financial transactions;
comparing, by the fraud assessment appliance, at least one current attribute data of the plurality of current attribute data to historical attribute data corresponding to a respective attribute of a plurality of historical financial transactions;
generating, by the fraud assessment appliance, a fraud assessment based, at least in part, on the comparing operation; and
generating, by the fraud assessment appliance, at least one of a fraud assessment report and a fraud alert signal based, at least in part, on the fraud assessment.

33. The method of claim 32, wherein the comparing operation further comprises comparing, by the fraud assessment appliance, a value of at least one current attribute data of the plurality of current attribute data to a value of historical attribute data corresponding to a respective attribute of a plurality of historical financial transactions;

34. The method of claim 32, wherein the comparing operation further comprises comparing, by the fraud assessment appliance, at least one current attribute data of the plurality of current attribute data with one or more statistical models based, at least in part, on a corresponding historical attribute data.

35. The method of claim 34, wherein the fraud assessment comprises a fraudulent activity notification when the at least one current attribute data exceeds a predetermined amount of deviation from the one or more statistical models.

36. The method of claim 32, wherein the comparing operation further comprises comparing, by the fraud assessment appliance, at least one current attribute data of the plurality of current attribute data with a frequency of the plurality of historical financial transactions.

37. The method of claim 36, wherein the frequency of the plurality of historical financial transactions includes the frequency of historical financial transactions associated with at least one of a payment instrument user, a shipping address, a billing address, a zip code, a geographical region, a payment instrument issuer, a payment gateway, a computing device, a plurality of computing devices, an internet protocol (IP) address and a range of IP addresses.

38. The method of claim 32, wherein the comparing operation further comprises comparing the plurality of current attribute data with a predetermined frequency value.

39. The method of claim 32, wherein the comparing operation further comprises comparing the plurality of current attribute data with historical attribute data previously identified as potentially fraudulent.

40. The method of claim 32, wherein the comparing operation further comprises comparing least one of an amount of historical financial transactions originating from a computing device and an amount of current financial transactions originating from the computing device with a predetermined value.

41. The method of claim 32, wherein the plurality of current attribute data comprises a plurality of name/value pairs, each of the name/value pairs being associated with a respective attribute of the plurality of historical financial transactions.

42. The method of claim 32, wherein the one or more current financial transactions corresponds to a collection of name/value pairs, each of the name/value pairs being associated with a respective attribute of the one or more current financial transactions.

43. An appliance for identifying potentially fraudulent financial transactions, comprising:
one or more attribute databases configured to store attribute data corresponding to respective attributes of a plurality of historical financial transactions;
a correlation component operably coupled to the one or more attribute databases, the correlation component configured to generate one or more correlated attribute data groups, and further configured to generate a plurality of statistical models, each statistical model associated with a respective one of the one or more correlated attribute data groups;
a fraud assessment component operably coupled to the correlation component, the fraud assessment component configured to generate a fraud assessment based, at least in part, on a comparison of an attribute data of one or more current financial transactions to at least one of the plurality of statistical models; and
a reporting component operably coupled to the fraud assessment component, the reporting component configured to generate at least one of a fraud assessment report and a fraud alert signal based, at least in part, on the fraud assessment.

44. The appliance of claim 43, wherein the attribute data comprises at least one of payment instrument identification data, transaction amount data, transaction description data, payment instrument security data, payment instrument user data, transaction identification data, originating computer data, internet protocol (IP) address data, payment gateway data, payment gateway identification data, payment instrument issuer identification data and payment instrument issuer data.

45. The appliance of claim 43, wherein the fraud assessment comprises a fraudulent activity notification when the attribute data of at least one of the current financial transactions exceeds a predetermined amount of deviation from the respective statistical model of the plurality of statistical models.

46. A system for identifying potentially fraudulent financial transactions, comprising:
one or more attribute databases configured to store a plurality of attribute data corresponding to respective attributes of a plurality of financial transactions;
a fraud assessment engine operably coupled to the one or more attribute databases, the fraud assessment engine configured to generate a fraud assessment based, at least in part, on an anomalous distribution of at least one of the plurality of attribute data; and
a reporting engine operably coupled to the fraud assessment engine, the reporting engine configured to generate at least one of a fraud assessment report and a fraud alert signal based, at least in part, on the fraud assessment.

47. The system of claim 46,
wherein the plurality of attribute data comprises payment instrument issuer data; and
wherein the anomalous distribution of at least one of the plurality of attribute data comprises more than a predetermined percentage of financial transactions associated with a payment instrument issuer.

48. A system for identifying potentially fraudulent financial transactions, comprising:
one or more attribute databases configured to store a plurality of attribute data corresponding to respective attributes of a plurality of financial transactions;
a fraud assessment engine operably coupled to the one or more attribute databases, the fraud assessment engine configured to generate a fraud assessment based, at least in part, on one or more statistical trends of at least one of the plurality of attribute data; and
a reporting engine operably coupled to the fraud assessment engine, the reporting engine configured to generate at least one of a fraud assessment report and a fraud alert signal based, at least in part, on the fraud assessment.

49. The system of claim 48,
wherein the one or more statistical trends of at least one of the plurality of attribute data comprises at least one of financial transactions originating from a single computer, financial transactions originating from a network of computers, financial transactions originating from a single internet protocol (IP) address, and financial transactions originating from a range of internet protocol (IP) addresses.
